(19) United States
(12) Patent Application Publication
(10) Pub. No.: US 2013/0080463 A1
(43) Pub. Date: Mar. 28, 2013

(54) SEARCHING APPARATUS, SEARCHING METHOD, AND RECORDING MEDIUM STORING SEARCHING PROGRAM

(71) Applicant: Kiichi Yamada, Numazu (JP)

(72) Inventor: Kiichi Yamada, Numazu (JP)

(73) Assignee: FUJITSU LIMITED, Kawasaki-shi (JP)

(21) Appl. No.: 13/614,628

(22) Filed: Sep. 13, 2012

(30) Foreign Application Priority Data
Sep. 26, 2011 (JP) 2011-208844

(51) Int. Cl. G06F 17/30

(52) U.S. Cl. 707/769; 707/E17.014

(57) ABSTRACT

A searching apparatus includes a processor that execute a procedure, the procedure including issuing a first instruction for searching a first data portion included in a search scope of a search request, based on a search request, issuing a second instruction for searching a second data portion included in the search scope of a search request, based on the search request, and in a case that another search request, a search scope of which includes second portion, is received before the second instruction is issued, issuing third instruction for collective searching, which includes obtaining data included in the second portion from a storage device and verifying the obtained data with both of the search request and the another search request, instead of the second instruction.

### CROSS-REFERENCE TO RELATED APPLICATION

This application is based upon and claims the benefit of priority of the prior Japanese Patent Application No. 2011-208844, filed on Sep. 26, 2011, the entire contents of which are incorporated herein by reference.

### FIELD

The embodiments discussed herein are related to searching technology.

### BACKGROUND

Documents that have been traditionally stored as paper are computerized and stored in databases by digitalizing information. By computerizing the documents, the contents of the documents may be searched using machines. Thus, the convenience of information search has been improved.

For a database that is accessed by many users using conventional data search techniques, the number of search requests to be processed is large, and a response time to return search results is long.

There is a search technique (collective search technique) for referencing data to be searched and collectively searching the referenced data on the basis of a plurality of search requests. Note that multiplicity is the number of search requests that are requested to be processed at one time.

As a conventional method for executing a collective search, there is the Aho-Corasick string matching algorithm. This algorithm enables data to be searched for a period of time that is proportional to the size of the data. The algorithm is a high-speed searching method that does not depend on the number of search keywords (strings to be searched).

In one of conventional techniques, received transactions are stacked until a predetermined criterion is satisfied, and the stacked transactions are collectively processed when the predetermined criterion is satisfied.

The collective search techniques each guarantee that when a load is high, a response time in a collective search is equal to or shorter than a certain value. The response time, however, largely vary in a range up to twice a period of time to execute the collective search.

### SUMMARY

According to an aspect of the invention, a searching apparatus includes a processor that execute a procedure, the procedure including issuing a first instruction for searching a first data portion included in a search scope of a search request, based on a search request, issuing a second instruction for searching a second data portion included in the search scope based on the search request, and in a case that another search request, a search scope of which includes the second data portion, is received before the second instruction is issued, issuing a third instruction for collective searching, which includes obtaining data included in the second data portion from a storage device and verifying the obtained data with both of the search request and the another search request, instead of the second instruction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a conventional method for processing a request to search data;

FIG. 2 illustrates an example of a method for reducing a delay in a response when access is highly concentrated;

FIG. 3 illustrates response times in a collective search;

FIG. 4 illustrates an example of the configuration of a system that includes a search request processing device according to an embodiment;

FIG. 5 is a flowchart of a whole process according to a configuration example of the embodiment;

FIG. 6 illustrates an example of a data structure;

FIG. 7 is a flowchart of a process that is executed by a request receiver;

FIG. 8A is a flowchart of a process that is executed by a search controller and a collective search unit;

FIG. 8B is a flowchart of the process that is executed by the search controller and the collective search unit;

FIG. 9A is a flowchart of a process that is executed by the search controller and the collective search unit according to another configuration example of the embodiment;

FIG. 9B is a flowchart of the process that is executed by the search controller and the collective search unit according to the other configuration example of the embodiment;

FIG. 10 illustrates an example of a method for determining the number of intervals;

FIG. 11 illustrates a change in the number of intervals; and

FIG. 12 illustrates a block configuration example of a computer that executes a program that achieves the embodiment.

### DESCRIPTION OF EMBODIMENTS

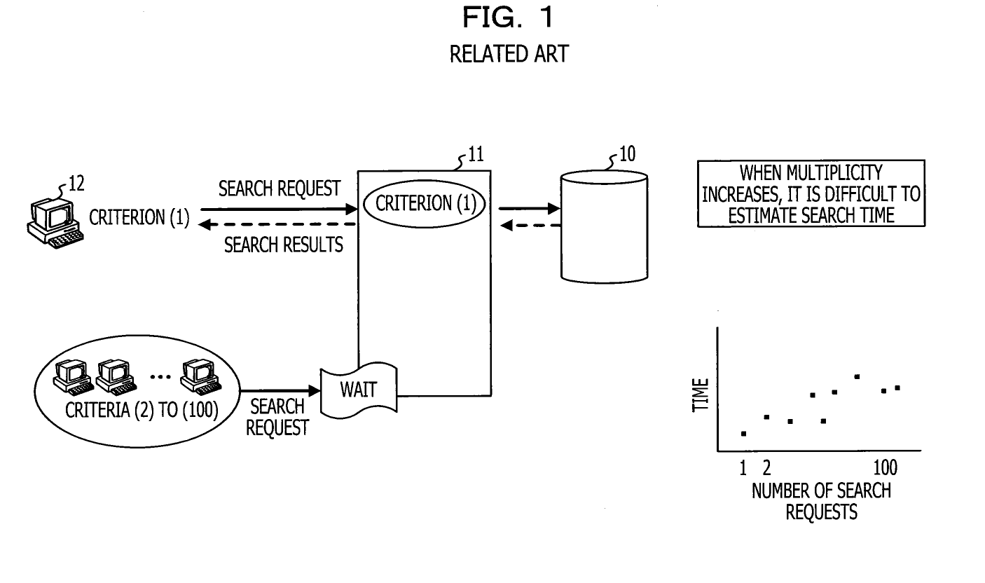

First, a method for processing a request to search data is described with reference to FIG. 1.

Data to be searched is stored in a database 10. Search criteria (1) to (100) to be searched are set in client terminals 12 by a plurality of users. Search requests that include the search criteria (1) to (100) are transmitted from the client terminals 12 to a search request processing device 11. The search request processing device 11 searches the data (to be searched) stored in the database 10 on the basis of the search criteria (1) to (100) and returns search results to the client terminals 12. In this case, the search request processing device 11 sequentially processes the search criteria one by one. When the search request processing device 11 is executing a search process on the basis of the search criterion (1) and the client terminals 12 that are used by the other users transmit search requests including the search criteria (2) to (100) to the search request processing device 11, the search requests are kept waiting until the search request processing device 11 completely executes the search process on the basis of the search criterion (1). Thus, for the database 10 that is accessed by many users, the number of search requests to be processed is large, and a response time to return search results is long.

In a graph illustrated on the right side of FIG. 1, the abscissa indicates the number of search requests, and the ordinate indicates a search time. The graph indicates a variation in the search time. Search requests are processed one by one. Thus, as the number of search requests increases, the search time more largely varies for various reasons. Note that multiplicity is the number of search requests that are requested to be processed at one time.

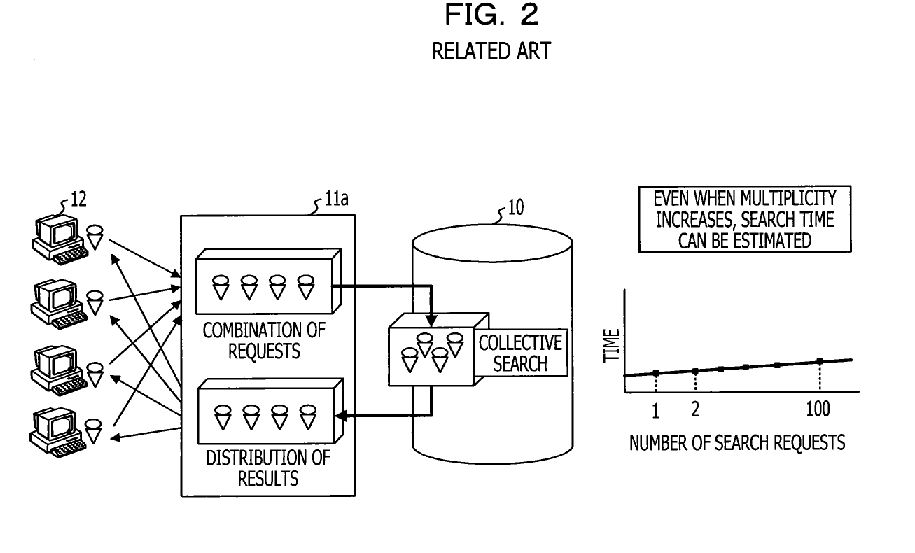

FIG. 2 is a diagram illustrating an example of a collective search technique for reducing a delay in a response when access is highly concentrated.

The technique illustrated in FIG. 2 is a technique for reducing a delay in a response and achieving a high throughput even when access is concentrated so as to cause an increase in a load (or even when the number of search requests that arrive at a search request processing device 11a per unit of time is large).

In the example illustrated in FIG. 2, the search request processing device 11a does not process the search requests received from the plurality of client terminals 12 one by one, combines the plurality of search requests and processes the combined search requests (or executes a search (hereinafter referred to as “collective search”) on the basis of the combined search requests).

The data to be searched is referenced on the basis of the combined search requests only once. Thus, even when the load is high, search results may be returned for a certain response time.

Since the collective search is executed, a plurality of search requests that arrive at the search request processing device 11a during the collective search are processed after the collective search. After the collective search, the search request processing device 11a combines the received search requests and executes the next collective search.

In a graph illustrated on the right side of FIG. 2, the abscissa indicates the number of search requests, and the ordinate indicates a search time. The graph indicates a variation in the search time. In a collective search, a plurality of search requests are collectively processed at one time. Thus, a period of time to keep each of search requests waiting is short. Even when the number of search requests is large, the search requests may be processed while the search time does not largely vary.

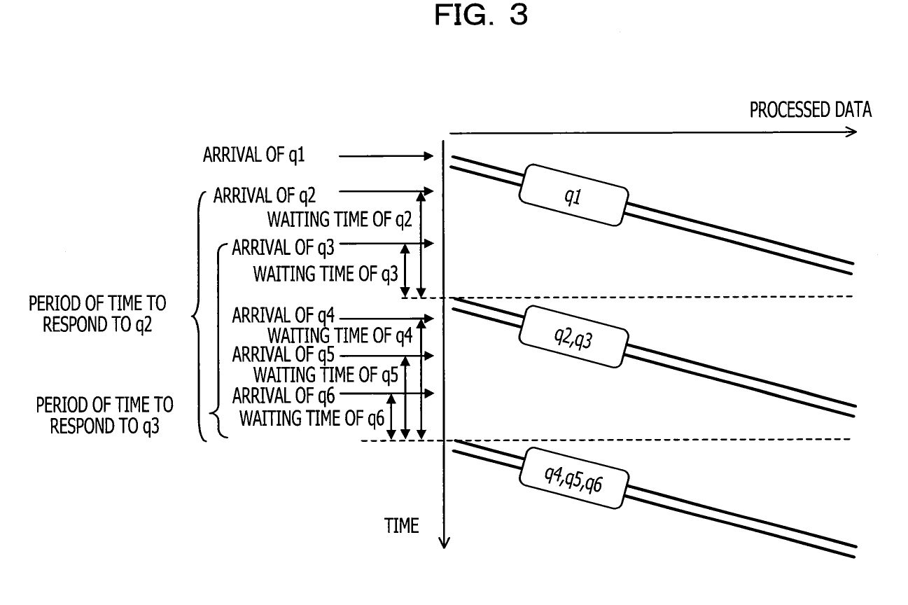

FIG. 3 is a diagram illustrating response times in a collective search.

Referring to FIG. 3, it is assumed that search requests q1 to q6 are sequentially input to a search request processing device that executes collective searches. First, the search request q1 arrives at the search request processing device. The search request processing device starts processing the search request q1. Before the search request q1 is completely processed, the search requests q2 and q3 sequentially arrive at the search request processing device. During the time when the search request processing device processes the search request q1, the search request processing device does not process another search request. Thus, the search requests q2 and q3 are kept waiting until the search request q1 is completely processed. When the search request q1 is completely processed, the search request processing device executes a collective search so as to collectively process the search requests q2 and q3. During the collective search, the search requests q4 to q6 arrive at the search request processing device. When the collective search is completed on the basis of the search requests q2 and q3, the search request processing device executes a collective search so as to collectively process the search requests q4 to q6.

When attention is directed to the search request q2, a waiting time from the arrival of the search request q2 to the start of the collective search to be executed on the basis of the search requests q2 and q3 is in a range up to a period of time to process the search request q1 (the waiting time is maximal when the search request q2 arrives immediately after the arrival of the search request q1). Then, a response to the search request q2 is obtained during a search time from the start to end of the collective search executed on the basis of the search requests q2 and q3. A period of time to search the whole data (to be searched) stored in a database on the basis of a single search request is nearly equal to a period of time to search the whole data stored in the database in a collective search. Thus, a period of time to respond to the search request q2 is equal to a period of time obtained by adding the maximum waiting time to the search time, or is in a range up to twice the period of time to execute the collective search.

A method for temporarily stopping a collective search every time a search request arrives and adding the arriving search request to the collective search (or for recombining all search requests and executing the collective search) may be considered. In this method, when the load is low, response times in the collective search may be reduced by reductions in waiting times of the search requests, and a variation in the response times in the collective search may be reduced. When the number of search requests increases and the load is high, however, a period of time to temporarily stop the collective search increases and the average response time in the collective search increases.

In a configuration example of an embodiment, when a new search request arrives, the search request is not necessarily added to a collective search (or not necessarily combined with the collective search). In the configuration example of the embodiment, whether or not the new search request is added to the collective search is determined on the basis of the current load. According to the configuration example, an increase in a response time may be suppressed.

First, a period of time to temporarily stop the collective search is measured. For example, the period of time to temporarily stop the collective search is estimated (calculated) on the basis of a past period of time to temporarily stop a collective search. As the estimated period of time to temporarily stop the collective search, the average of a plurality of past periods of time to temporarily stop the collective search is used. Next, a period of time to execute the collective search is measured. For example, a time to terminate the collective search that is being executed is estimated (calculated) on the basis of a past collective search. In order to estimate the time to terminate the collective search, the average of a plurality of past periods of time to execute collective searches is used.

It is assumed that when a new search request arrives, a collective search is temporarily stopped and the new search request is added to the collective search. Based on this assumption, the amount of an increase in a period of time to respond to search requests for which the collective search is being executed is calculated on the basis of the estimated period of time to temporarily stop the collective search and the estimated time to terminate the collective search that is being executed (an adverse effect or disadvantage obtained when the new search request is added is calculated). In addition, based on the assumption, the amount of a reduction in a period of time to respond to the new search request is calculated on the basis of the estimated period of time to temporarily stop the collective search and the estimated time to terminate the collective search (an effect or advantage obtained when the new search request is added is calculated).

Based on the assumption, a change in the total period of time to respond to the search requests is calculated on the basis of the calculated amounts. When the total period of time to respond to the search requests is reduced, the collective search that is being executed is temporarily stopped and the arriving search request is actually added to the collective search. When the total period of time to respond to the search requests increases, the arriving search request is not added and the collective search is suspended (or the arriving search request is kept waiting).

In the embodiment, whether a high throughput for a search or a short period of time to respond to a search request is prioritized is automatically calculated on the basis of the current load, and the high throughput or the short period of time to respond to the search request is achieved.

According to the embodiment, for a user of a search system, a period of time to respond to search requests is reduced, and a variation in periods of time to respond to the search requests is reduced. For a provider of the search system, even when the load is high regardless of the reduction in the period of time to respond to the search requests, a high throughput is maintained. For a designer of a business system that includes the search system, since the search system automatically changes its operation on the basis of the current load, a cost (of the business system) estimated during design and the cost for testing the business system are reduced.

In another configuration example of the embodiment, a newly arriving search request is necessarily combined with a collective search, and a unit of data to be searched in the collective search may be set so that a response time is short. Data to be searched may be divided into groups and the unit of data to be searched in the collective search may be equal to a unit of each of the groups. The number of groups into which the data to be searched is divided may be changed so that the response time is shorter.

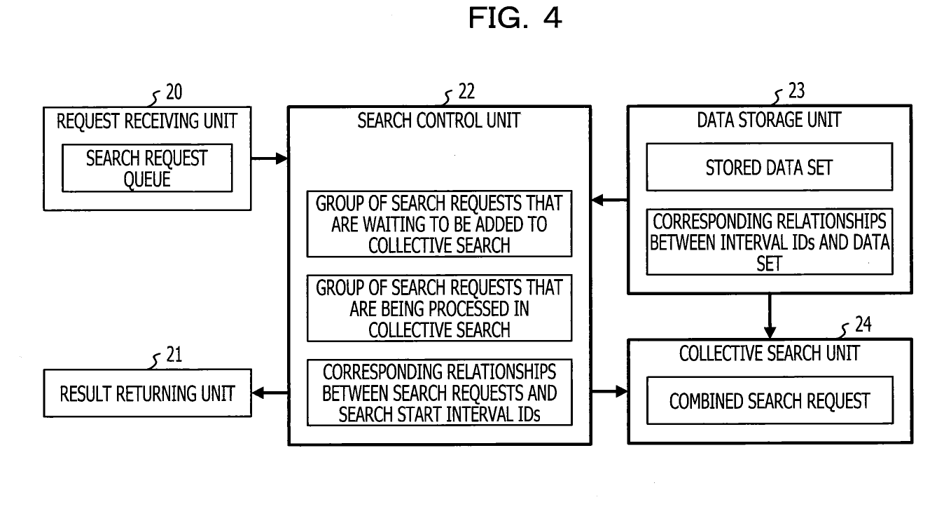

FIG. 4 is a diagram illustrating the configuration of a system that includes a search request processing device according to the embodiment.

The search request processing device according to the embodiment includes a request receiving unit 20, a result returning unit 21, a search control unit 22 and a collective search unit 24. The request receiving unit 20 receives search requests. The result returning unit 21 returns search results to a client terminal. The search control unit 22 controls how to execute a search. The collective search unit 24 executes a collective search. A data storage unit (database) 23 stores a data set to be searched. The system includes the request receiving unit 20, the result returning unit 21, the search control unit 22, the data storage unit 23 and the collective search unit 24. For example, the system may include two or more search request processing devices. For example, one of the two or more search request processing device includes the request receiving unit 20, a request returning unit 21 and a search control unit 22, and other search request processing devices include the collective search unit 24.

The request receiving unit 20 receives search requests from the client terminal and stores the received search requests in a search request queue. The search requests are extracted from the search request queue and transmitted to the search control unit 22. The search control unit 22 holds a group of the search requests that have been transmitted by the request receiving unit 20 and are waiting to be added to a collective search. In addition, the search control unit 22 holds a group of search requests that are currently being processed in the collective search. The search control unit 22 divides the data set stored in the data storage unit 23 into groups. In order to search the groups on a group basis, the search control unit 22 provides IDs (search interval IDs) to the groups that are search intervals. The search control unit 22 sets corresponding relationships between search requests and search start interval IDs of the search requests. The corresponding relationships are examples of instruction information, issued by the search control unit 22, for collective searching processed by the collective search unit 24.

The collective search unit 24 holds a search request that has been formed by combining a plurality of search requests and is to be processed in the collective search. The data storage unit 23 holds the stored data set and corresponding relationships between the search interval IDs and the data set included in intervals identified by the search interval IDs.

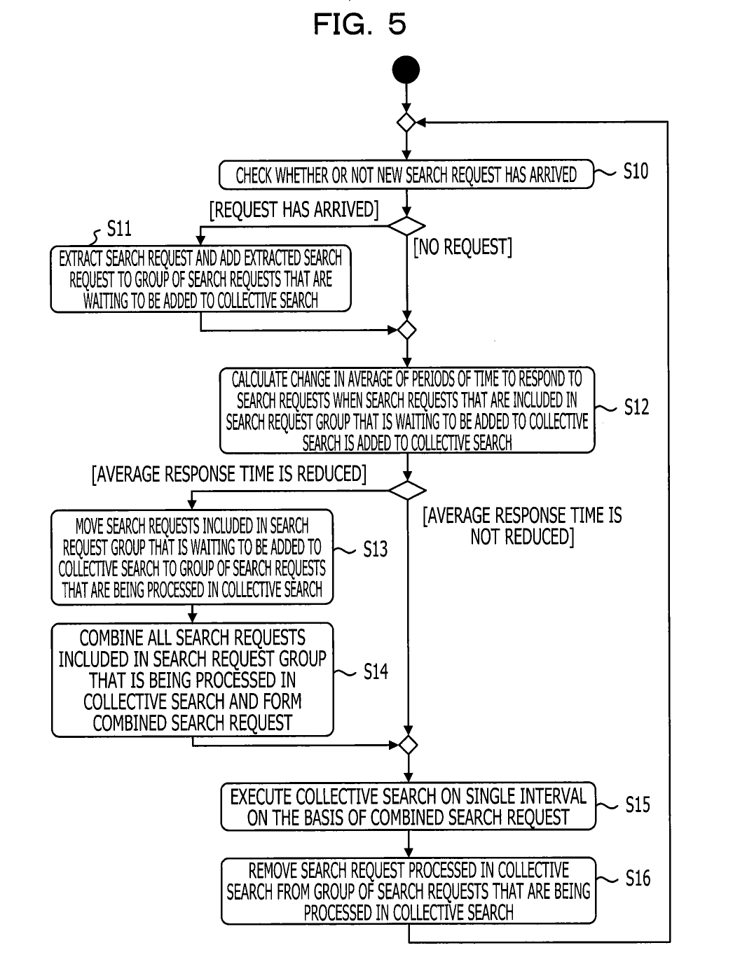

FIG. 5 is a flowchart of a whole process that is executed in the configuration example of the embodiment.

The stored data set that is divided into the intervals is searched on an interval basis in the collective search. The collective search is executed while the whole stored data set is searched in a rotation.

In S10, it is determined whether or not a new search request has arrived at the search request processing device. When it is determined that the new search request has not arrived in S10, the process proceeds to S12. When it is determined that the new search request has arrived in S10, the search request is added to a group of search requests that are waiting to be added to the collective search.

In S12, a change in the average of periods of time to respond to search requests when the search requests that are waiting to be added to the collective search are added to the collective search is calculated. When it is determined that the average is reduced in S12, the process proceeds to S13. When it is determined that the average is not reduced in S12, the process proceeds to S15. In S13, the search requests that are included in the search request group that is waiting to be added to the collective search are moved to a group of search requests that are being processed in the collective search. In S14, all the search requests that are included in the search request group that is being processed in the collective search are combined to form a combined search request.

In S15, a single interval is searched in the collective search using the current combined search request regardless of whether or not the search requests that are included in the search request group that is waiting to be added to the collective search are moved. In S16, when a search request that is completely processed in the collective search exists, the search request is removed from the group of search requests that are being processed in the collective search. Then, the process returns to S10.

When it is determined that the average is not reduced in S12 and the search requests that are waiting to be added to the collective search are not added to the collective search, the number of search requests that are waiting to be added to the collective search increases. The collective search, however, is in progress. Thus, the number of search requests that are being processed in the collective search is reduced and finally becomes zero. When the number of search requests that are being processed in the collective search is reduced, the disadvantage that is obtained by adding a search request that is waiting to be added to the collective search to the collective search is reduced. Thus, it is determined that the average is reduced in S12, and a search request that is waiting to be added to the collective search is necessarily processed in the collective search.

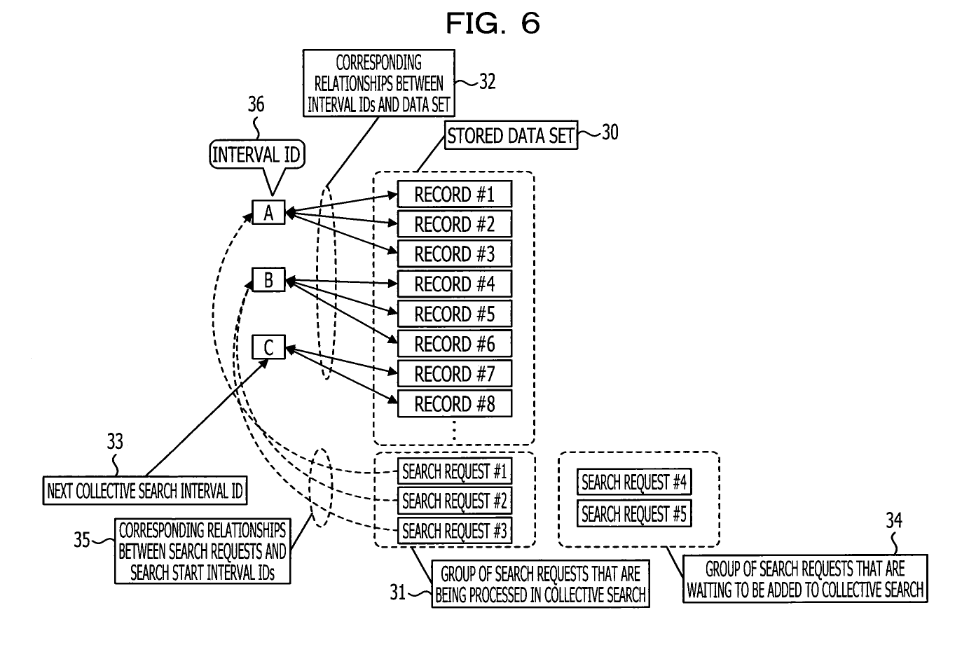

FIG. 6 is a diagram illustrating a data structure.

A stored data set 30 is data stored in the system, for example, in a database. Interval IDs 36 are identifiers that identify intervals that are to be searched and are groups into which the stored data set 30 is divided. A group 31 is a group of search requests that are being processed in a collective search and yet to be completely processed. Corresponding relationships 32 between the interval IDs and the stored data set 30 are corresponding relationships between the interval IDs identifying the groups obtained by dividing the stored data set 30 and data pieces classified into the intervals. A next collective search interval ID 33 identifies an interval that is next searched in the collective search that is to search the whole stored data set in a rotation in order from a first record. A group 34 is a group of search requests that are waiting to be added to the collective search. Corresponding relationships 35 between search requests and search start interval IDs are corresponding relationships between the search requests combined with the collective search and the interval IDs identifying intervals from which searches have started.

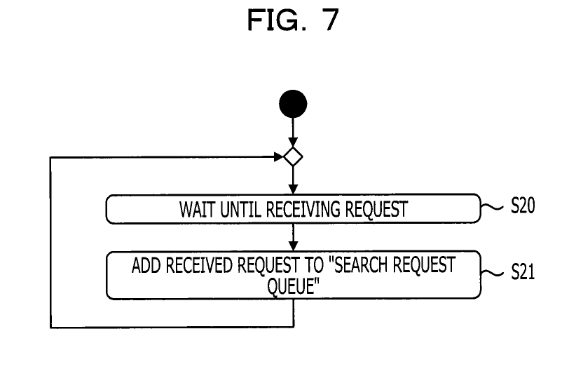

FIG. 7 is a flowchart of a process that is executed by the request receiving unit 20.

In S20, the request receiving unit 20 waits until receiving a search request from a client terminal that is used by a user. When the request receiving unit 20 receives the search request, the request receiving unit 20 accepts the received search request and adds the received search request to the search request queue in S21.

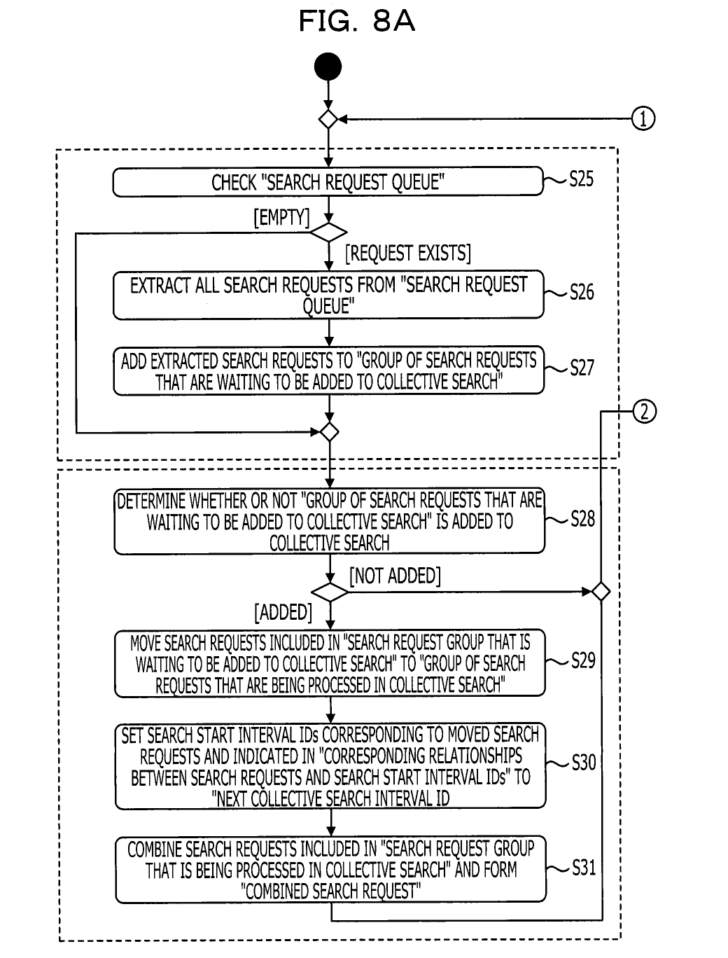

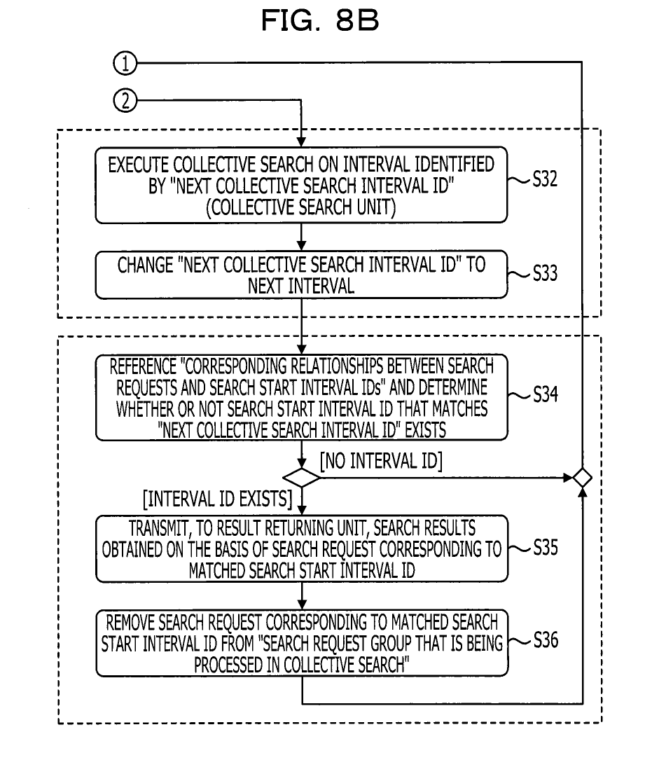

FIGS. 8A and 8B are flowcharts of a process that is executed by the search control unit 22 and the collective search unit 24.

The process illustrated in FIGS. 8A and 8B is mainly divided into a process of extracting a search request (in S25 to S27), a start process (in S28 to S31) to be executed on the search request, a process of executing a collective search (in S32 to S33) and a termination process (in S34 to S36) to be executed on the search request.

In S25, the search request queue is checked. When a new search request exists in the search request queue, the new search request is extracted from the search request queue. Specifically, when it is determined that the search request queue is empty in S25, the process proceeds to S28. When it is determined that the new search request exists in S25, the search request is extracted from the search request queue and added to a group of search requests that are waiting to be added to the collective search in S27. Then, the process proceeds to S28.

In S28, it is determined whether or not the group of search requests that are waiting to be added to the collective search is added to the collective search. When it is determined that the group of search requests is not added in S28, the process proceeds to S32. When it is determined that the group of search requests is added in S28, the start process is substantially executed on the search request.

In the start process, information of the new search request is added to information held by the search control unit 22. In S29, the search requests that are included in the search request group that is waiting to be added to the collective search are moved to the group of search requests that are being processed in the collective search. In S30, each of intervals that are identified by search interval IDs indicated in corresponding relationships between the moved search requests and the search interval IDs is set to an interval identified by the next collective search interval ID obtained when the search requests have been received. In S31, all the search requests that are being processed in the collective search are combined using such a conventional technique as illustrated in FIG. 2, while the conventional technique is to combine search requests.

Next, the collective search is executed on a single interval. Specifically, in S32, the collective search is executed on the interval included in the stored data set and identified by the next collective search interval ID. In S33, the interval that is identified by the next collective search interval ID is changed to the next interval. Then, the process proceeds to S34. When a search request that is completely processed in the collective search exists after the collective search, the termination process is executed on the search request in S34 to S36.

Whether or not the search request has been completely processed in the collective search is determined on the basis of an interval ID. Specifically, in S34, the corresponding relationships between the search requests and the search start interval IDs are referenced, and it is determined whether or not a search start interval ID that is indicated in the corresponding relationships between the search requests and the search start interval IDs and matches the next collective search interval ID exists. The search start interval ID on which the collective search starts to be executed is obtained by referencing the corresponding relationships between the search requests and the search start interval IDs. Thus, when the interested interval ID matches the next collective search interval ID, the matching means that the whole data set (to be searched) has been searched in a rotation on the basis of the interested search request in the collective search. Thus, it may be determined that the search request has been completely processed in the collective search.

When it is determined that any of the search start intervals ID does not match the next collective search interval ID in S34, the process returns to S25. When it is determined that any of the search start intervals ID matches the next collective search interval ID in S34, search results that are obtained on the basis of the search request corresponding to the search start interval ID matching the next collecting search interval ID are transmitted to the result returning unit 21 in S35. In this case, the search results are collectively transmitted to the result returning unit 21. The search results, however, may be transmitted to the result returning unit 21 on an interval basis. After the result returning unit 21 returns the search results to a client terminal, information of the interested search request is removed from the corresponding relationships between the search requests and the search start interval IDs and the group of search requests that are being processed in the collective search in S36. Then, the process returns to S25.

A method for the determination of S28 illustrated in FIG. 8A is described below.

The determination of S28 is made by the search control unit 22.

An example of the determination that is made by the search control unit 22 as to whether the search requests that are waiting to be added to the collective search are added to the collective search is described below.

The meanings of symbols that are used in the following description are as follows. A symbol M indicates the number of intervals of the stored data set. A symbol L indicates a period of time (seconds) to execute the collective search on all the intervals. A symbol qs indicates the number of search requests included in “a search request group that is being processed in a collective search”. A symbol qw indicates the number of search requests included in “a search request group that is waiting to be added to the collective search”.

Before a certain interval starts to be searched, it is determined whether a search request that is waiting to be added to the collective search is added to the collective search and starts to be processed from a search of the certain interval or is added to the collective search and starts to be processed from a search of the next interval or a later interval.

(1) Calculation of Advantage

An advantage that is obtained when the search request does not start to be processed from the search of the next interval or a later interval and is added to the group of search requests that are being processed in the collective search and starts to be processed from the search of the current interval is that a period of time for the search request to wait to be added to the collective search is reduced by a period of time to search a single interval to be searched and whereby a period of time to respond to the search request is reduced.

The sum B of reductions in periods of time for the search requests to wait to be added to the collective search is represented by an equation of B=L1×qw, where L1 indicates the period of time to search the single interval.

The period of time to search the single interval is calculated from a period L of time to execute the collective search on all the intervals, and L1=L/M.

The period L of time to execute the collective search on all the intervals may be calculated by measuring periods of time to execute collective searches on all the intervals and calculating the average of the past periods of time. In addition, the period L of time may be calculated on the basis of the amount of the stored data set and performance of hardware. The performance of the hardware may be the frequency of a clock signal of a CPU or a clock speed for searching one-byte data. The amount of the stored data set is the number of bytes of the stored data or the like. Thus, the period L of time to execute the collective search on all the intervals may be estimated.

(2) Calculation of Disadvantage

A disadvantage that is obtained when the search request does not start to be processed from the search of the next interval or a later interval and is added to the group of search requests that are being processed in the collective search and starts to be processed from the search of the current interval is that a period of time to stop the collective search executed on the basis of the search requests included in the search request group that is being processed in the collective search increases by a period of time to add the search request to the collective search and whereby the period of time to respond to the search request increases.

When a period of time to add search requests to the collective search or a period of time to stop the collective search is indicated by S (seconds), the sum C of the amounts of increases in periods of time to respond to the search requests is represented by the following equation:

C=S×qs.

The period S of time to stop the collective search may be calculated by measuring a past period of time to stop the collective search (or a past period of time to add a search request to the collective search).

In a conventional technique, since a period of time to add search requests to a collective search is proportional to the number of search requests to be processed in the collective search, a period of time to stop the collective search may be calculated on the basis of the number of the search requests to be processed.

(3) Determination

The advantage calculated in item (1) and the disadvantage calculated in item (2) are compared with each other. When the advantage is larger than the disadvantage, a group of search requests that are waiting to be added to the collective search may be added to the collective search.

Another configuration example that is different from the determination made by the search control unit 22 as to whether or not a search request that is waiting to be added is added to the collective search is described below.

In the aforementioned configuration example, the stored data set is divided into groups, and every time a search request arrives, the search control unit 22 determines whether or not the search request is added to the collective search.

In the other configuration example, every time the collective search is completely executed on an interval, an arriving search request is added to the collective search and the division of the stored data set (or the number of divided intervals) is dynamically changed. Thus, the timing of adding a search request to the collective search may be controlled without a determination to be made as to whether the search request is added to the collective search for each of intervals.

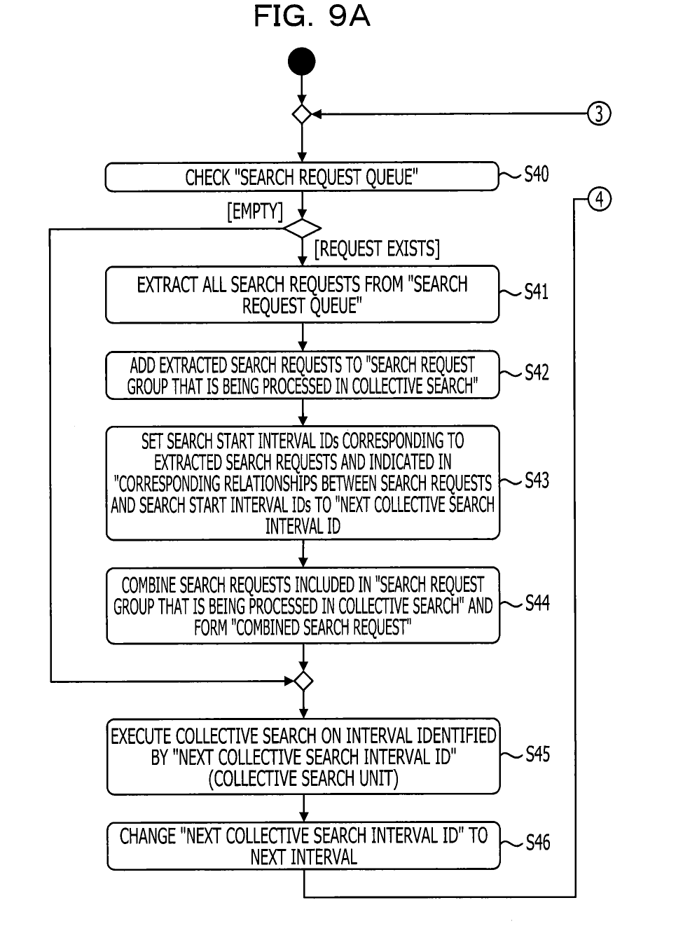

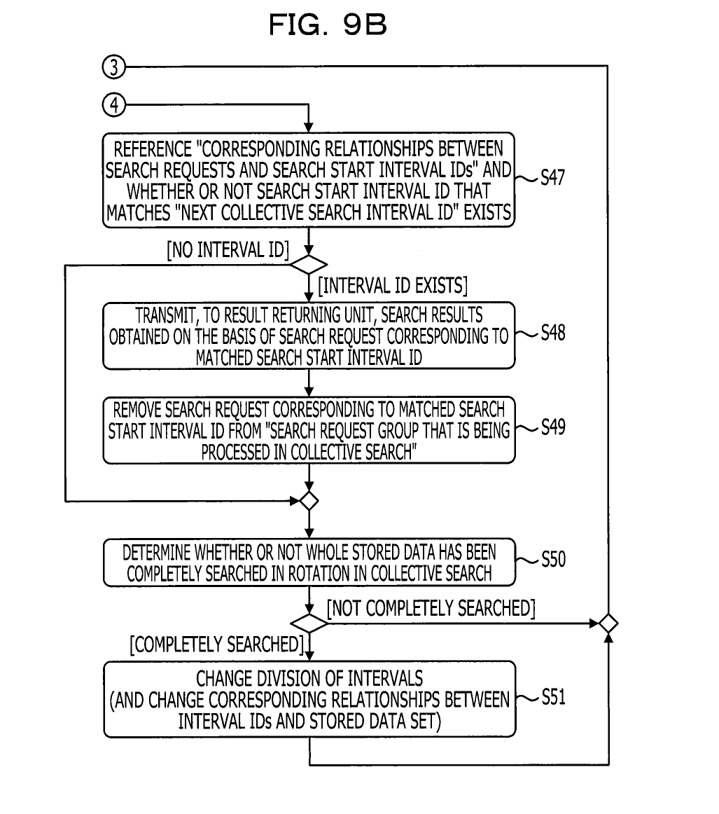

FIGS. 9A and 9B are flowcharts of a process that is executed by the search control unit 22 and the collective search unit 24 in the other configuration example of the embodiment.

In S40, the search request queue is checked. When a new search request exists in the search request queue in S40, the process of extracting the search request is executed. When the new search request does not exist in S40, the process proceeds to S45.

In S41, all search requests that are stored in the search request queue are extracted. In S42, the extracted search requests are added to a group of search requests that are being processed in a collective search. In S43, search start interval IDs corresponding to the extracted search requests are associated with the next collective search interval ID and set to the next collective search interval ID. In S44, the search requests that are included in the search request group that is being processed in the collective search are combined to form a combined search request.

In S45, an interval that is identified by the next collective search interval ID is searched in the collective search regardless of whether or not the search request has been added. When a search request that has been completely processed in the collective search after the collective search exists, the termination process is executed on the search request. In S46, the interval identified by the next collective search interval ID is changed to the next interval. Then, the process proceeds to S47. In S47, corresponding relationships between search requests and search start interval IDs are referenced, and it is determined whether or not a search request corresponding to a search start interval ID that is indicated in the corresponding relationships between the search requests and the search start interval IDs and matches the next collective search interval ID exists.

When it is determined that the search request corresponding to the search start interval ID that matches the next collective search interval ID does not exist in S47, the process proceeds to S50. When it is determined that the search request exist in S47, search results that are obtained on the basis of the search request corresponding to the search start interval ID that matches the next collective search interval ID are transmitted to the result returning unit 21 in S48. In S49, the search request corresponding to the search start interval ID that matches the next collective search interval ID is removed from the group of search requests that are being processed in the collective search.

In S50, it is determined whether or not the whole stored data has been completely searched in a rotation in the collective search. When it is determined that the whole stored data is yet to be completely searched in S50, the process returns to S40. When it is determined that the whole stored data has been completely searched in S50, the division of the intervals is changed and the corresponding relationships between the interval IDs and the stored data set are changed in S51. Then, the process returns to S40.

The present configuration example is different from the configuration example described with reference to FIGS. 8A and 8B in that the division of intervals is periodically checked. The flowchart of FIGS. 9A and 9B is an example in which the division of intervals is checked when the whole data set is completely searched in a rotation in the collective search. When the whole data set is completely searched, the division of intervals is checked and may be changed.

An example of a method for checking the division of intervals is described below.

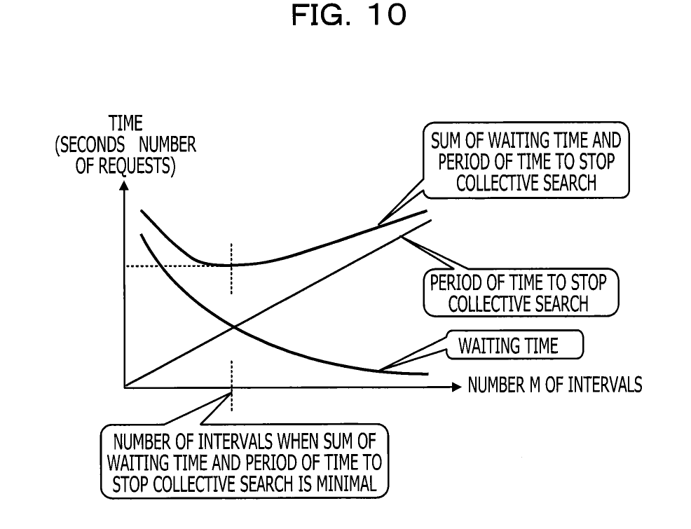

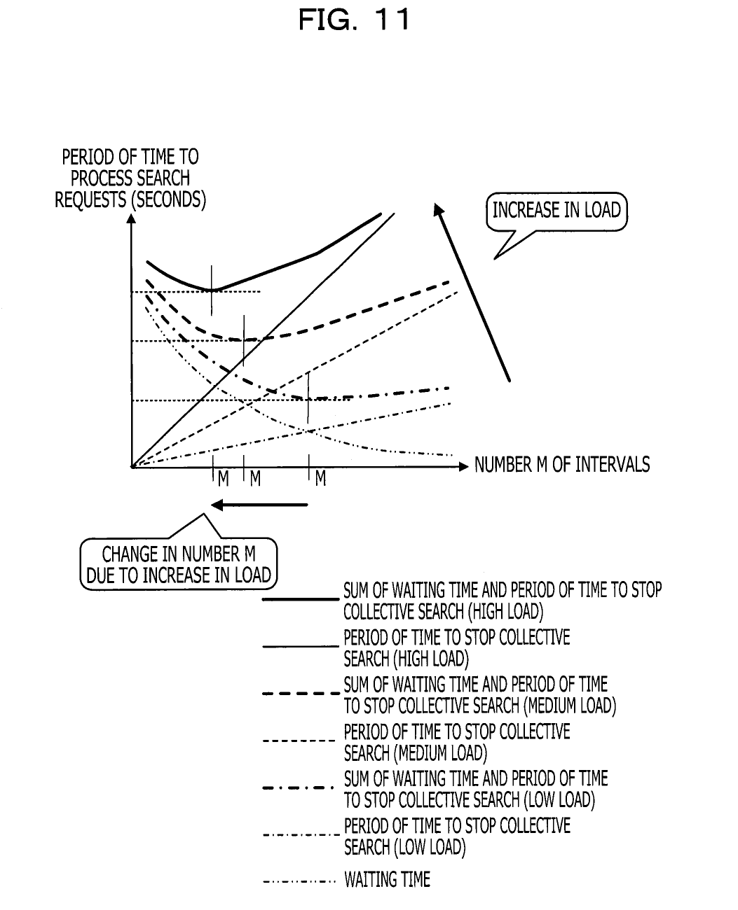

FIG. 10 is a diagram describing a method for determining the number of intervals. FIG. 11 is a diagram illustrating a change in the number of intervals.

The meanings of symbols that are used in the following description are as follows. A symbol M indicates the number of intervals of the stored data set. A symbol L indicates a period of time (seconds) to execute a collective search on all the intervals. A symbol Q indicates the number of search requests that has arrived during the time when the whole stored data set is searched in a rotation in the collective search.

The purpose of the method is to calculate an appropriate number M of intervals.

The number M of intervals is determined by comparing an advantage (effect) obtained by adding a new search request to the collective search during the collective search with a disadvantage (adverse effect) obtained by adding the new search request to the collective search during the collective search.

(1) Advantage Obtained by Adding Search Request to Collective Search

The advantage is a reduction in a waiting time from arrival of the new search request to the addition of the search request to the collective search.

The average of waiting times of search requests is equal to a half of a period of time to execute a collective search on a single interval. When the average is w1 (seconds), w1=L/(M×2). The average w1 is inversely proportional to the number M of intervals. As the number M of intervals increases, the average w1 of the waiting times is reduced, but the amount of the reduction in the average w1 is gradually reduced. The number M is multiplied by 2 in order to reduce the average w1 by half. A search request may be added to the collective search without a waiting time or added to the collective search after a period of time to execute a collective search on a single interval. A distribution of the waiting times is considered to be random. It is, therefore, considered to be appropriate that the average of the waiting times is equal to a half of the period of time to execute a collective search on a single interval.

When the sum of the waiting times of the search requests during the time when the whole stored data set is searched in a rotation in the collective search is indicated by W, W=w1×Q=Q×L/(M×2).

(2) Disadvantage

The disadvantage is an increase in the period of time to stop the collective search, while the increase is caused by an increase in the number M of intervals. The sum of periods of time to stop the collective search is represented by the following equation.

When a period of time to stop the collective search once between intervals is indicated by s1 (seconds), the sum S of periods of time to stop the collective search for all intervals is represented by the following equation: S=s1×Q×M. The sum S increases in proportion to the number M of intervals.

(3) Determination

It is sufficient if the number M of intervals when the total of the sum (calculated in item (1)) of the waiting times and the sum (calculated in item (2)) of the periods of time to stop the collective search is minimal is calculated. FIG. 10 illustrates a graph indicating the advantage, the disadvantage and the sum of the advantage and the disadvantage. In FIG. 10, the abscissa indicates the number of intervals and the ordinates indicates time. Referring to FIG. 10, the number M of intervals when the sum of waiting times of search requests and periods of time to stop the collective search is minimal is a value to be calculated. The sum of the waiting times and the periods of time to stop the collective search is differentiated with respect to the number M. An equation that indicates the number M when the differentiated sum is 0 is given below.

The number M when the differentiated sum is 0 is represented by the equation:

M=√(L/(2×s1)).

When the Aho-Corasick string matching algorithm is used as an algorithm for the collective search, a period of time to add a new search request to the collective search during the collective search or a period s1 of time to stop the collective search increases depending on the number of search requests that are included in the collective search. When the levels of complexity of the search requests are equal or nearly equal to each other, the period s1 of time increases in proportion to the number of search requests that are included in the collective search.

The number of search requests that are processed in a collective search to be executed on a certain interval is, on average, equal to the number of search requests that arrives during the time when the whole stored data set is searched in a rotation in the collective search (this is due to the fact that even when any of intervals starts to be searched, the collective search is not terminated until all the intervals are searched). Thus, the period s1 of time to stop the collective search is represented by the following equation: s1=Q×α, where α is a certain value that indicates a period of time to stop the collective search for a single search request.

When the number M of intervals is to be recalculated on the basis of a measured past period L of time to execute the collective search on all the intervals and the period s1 of time to stop the collective search, and the current load changes compared with a past load (or the number Q of search requests that have arrived increases or is reduced), the measured period s1 of time to stop the collective search may be corrected using a characteristic in which the period s1 of time to stop the collective search for a single interval is proportional to the number Q of the search requests.

When the measured period of time to stop the collective search is indicated by s1′, the number of search requests when the period s1′ of time is measured is indicated by Q′, and the current number of search requests is indicated by Q, the corrected period s1 of time is represented by the following equation:

s1=s1′×Q/Q′.

When the number M of intervals is calculated on the basis of the corrected period s1 of time, the number M of intervals may be controlled on the basis of a variation in the load.

When the period s1 of time is substituted into the equation indicating the sum S, S=Q×α×Q×M=α×Q²×M.

The equation that indicates the sum W of the waiting times does not change. Thus, when the period s1 of time is substituted into the equation indicating the number M, M=√(L/(2×Q×α)). As the number Q increases, the number M of intervals when the sum of the waiting times and the periods of time to stop the collective search is minimal is reduced. FIG. 11 illustrates a change in the number M of intervals with respect to an increase in the load (number of search requests that have arrived during the time when the whole data set is searched in a rotation in the collective search). In FIG. 11, the abscissa indicates the number M of intervals, while the ordinate indicates a period of time to process search requests. It is apparent from FIG. 11 that as the load increases, the number M is reduced.

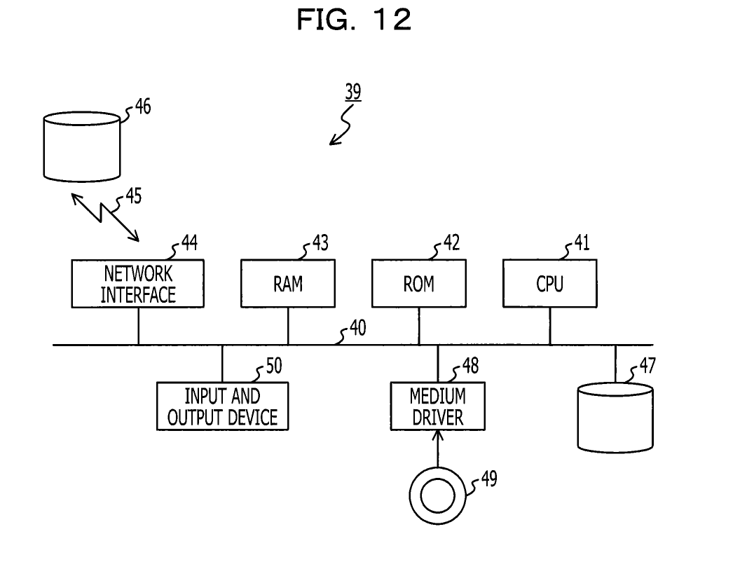

FIG. 12 is a block diagram illustrating the configuration of a computer that executes a program that achieves the embodiment.

A computer 39 includes a CPU 41, a ROM 42, a RAM 43, a network interface 44, a storage device 47, a medium driver 48 and an input and output device 50, which are connected to each other through a bus 40. The CPU 41 is an example of a processor that reads out and executes programs including aforementioned procedures.

A program that is a typical BIOS or the like and executed in order to operate the computer 39 is stored in the ROM 42. The CPU 41 reads the BIOS or the like from the ROM 42 and causes the computer 39 to operate.

Programs to be executed, which include the aforementioned programs, are loaded into the RAM 43 so that the CPU 41 may execute the programs. The RAM 43 has a work region to be used for processing of the programs.

The storage device 47 is a hard disk or the like. Various programs (aforementioned searching program, for example) are stored in the storage device 47. The programs stored in the storage device 47 include a basic program such as an OS and the program that achieves the processes described in the embodiment. The programs stored in the storage device 47 are loaded into the RAM 43 and executed by the CPU 41. The program that achieves the processes described in the embodiment may be stored in the storage device 47.

The medium driver 48 reads a program stored in a portable recording medium 49 such as a CD-ROM, a DVD, a Blu-ray disc, a flexible disk or an IC memory. The program that achieves the processes described in the embodiment may be stored in the portable recording medium 49. The programs that are read from the portable recording medium 49 by the medium driver 48 are loaded into the RAM 43 and executed by the CPU 41.

The input and output device 50 includes an input device such as a keyboard or a tablet and an output device such as a display or a printer. A user uses the input device to enter information and obtains results of processing of the programs.

The network interface 44 connects the computer 39 through a network 45 to a computer owned by an information provider 46, or to a database or the like. The program according to the embodiment may be provided to the computer 39 from the information provider 46 through the network 45. In this case, the program may be temporarily stored in the storage device 47 or the portable recording medium 49. After being temporarily stored, the program may be loaded into the RAM 43 and executed by the CPU 41. In addition, the program according to the embodiment may be executed on the computer owned by the information provider 46, while the computer 39 may receive and output data through the input and output device 50.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A searching apparatus comprising:
a memory; and
a processor that executes a program, stored in the memory, including a procedure, the procedure including:
issuing a first instruction for searching a first data portion included in a search scope of a search request, based on the search request;
issuing a second instruction for searching a second data portion, included in the search scope, based on the search request; and
in a case that another search request, a search scope of which includes the second data portion, is received before the second instruction is issued, issuing third instruction for collective searching, which includes obtaining data included in the second data portion from a storage device and verifying the obtained data with both of the search request and the another search request, instead of the second instruction.

2. The searching apparatus according to claim 1, wherein the procedure further includes:
issuing forth instruction for searching the first data portion based on the another search request after the third instruction is issued.

3. The searching apparatus according to claim 1, wherein the procedure further includes:
issuing the second instruction and a fifth instruction for searching the second data portion based on the second search request, instead of the third instruction, in response to estimated execution time of the collective searching.

4. A searching method comprising:
issuing a first instruction for searching a first data portion included in a search scope of a search request, based on the search request;
issuing a second instruction for searching a second data portion, included in the search scope, based on the search request; and
in a case that another search request, a search scope of which includes the second data portion, is received before the second instruction in issued, issuing third instruction for collective searching, which includes obtaining data included in the second data portion from a storage device and verifying the obtained data with both of the search request and the another search request, instead of the second instruction, by a processor.

5. The searching method according to claim 4, further comprising:
issuing forth instruction for searching the first data portion based on the another search request after the third instruction is issued.

6. The searching method according to claim 4, further comprising:
issuing the second instruction and a fifth instruction for searching the second data portion based on the second search request, instead of the third instruction, in response to estimated execution time of the collective searching.

7. A computer-readable recording medium storing a searching program that causes a computer to execute a procedure, the procedure including:
issuing a first instruction for searching a first data portion included in a search scope of a search request, based on the search request;
issuing a second instruction for searching a second data portion, included in the search scope, based on the search request; and
in a case that another search request, a search scope of which includes the second data portion, is received before the second instruction is issued, issuing third instruction for collective searching, which includes obtaining data included in the second data portion from a storage device and verifying the obtained data with both of the search request and the another search request, instead of the second instruction.

8. The recording medium according to claim 7, wherein the procedure further includes:
issuing forth instruction for searching the first data portion based on the another search request after the third instruction is issued.

9. The recording medium according to claim 7, the procedure further includes:
issuing the second instruction and a fifth instruction for searching the second data portion based on the second search request, instead of the third instruction, in response to estimated execution time of the collective searching.
